(19) United States
(12) Patent Application Publication
(10) Pub. No.: US 2011/0303359 A1
(43) Pub. Date: Dec. 15, 2011

(54) ROLL-TO-ROLL MANUFACTURING OF BACK-CONTACTED SOLAR CELLS

(76) Inventors: Jeroen K. J. Van Duren, Palo Alto, CA (US); Jayna R. Sheats, Palo Alto, CA (US); Phil Stob, Fremont, CA (US)

(21) Appl. No.: 12/777,241

(22) Filed: May 10, 2010

Related U.S. Application Data
(60) Provisional application No. 61/176,902, filed on May 9, 2009.

(51) Int. Cl. B32B 37/14

(52) U.S. Cl. 156/306.6

(57) ABSTRACT

Methods and devices are described for thin film solar cell manufacturing. In one embodiment, the method includes using an energy increase as a catalyst to laminate a first metal layer to a second metal layer with an electrically insulating layer therebetween without damaging an absorber layer formed on the first metal layer

### CROSS-REFERENCE TO RELATED APPLICATION

This application claims priority to U.S. Provisional Application Ser. No. 61176902 filed May 9, 2009 and fully incorporated herein by reference for all purposes.

This invention was made with Government support under Contract No. DE-FC36-07GO17047 awarded by the Department of Energy. The Government has certain rights in this invention.

### FIELD OF THE INVENTION

This invention relates to solar cells and more specifically to back-contacted solar cells.

### BACKGROUND OF THE INVENTION

There is a need for an improved back-contacted solar cell with improved manufacturability.

### SUMMARY OF THE INVENTION

The disadvantages associated with the prior art are overcome by embodiments of the present invention. Embodiments of the invention may be used for high throughput, high precision manufacturing for roll-to-roll production systems. The embodiments are applicable to various thin film absorbers such as but not limited to polycrystalline CIGS (copper indium gallium di-selenide, but not excluding any other of the IB, IIIA, VIA elements like e.g. aluminum, and sulfur).

A further understanding of the nature and advantages of the invention will become apparent by reference to the remaining portions of the specification and drawings.

### BRIEF DESCRIPTION OF THE DRAWINGS

FIG. 1 shows one embodiment of the present invention.

### DESCRIPTION OF THE SPECIFIC EMBODIMENTS

It is to be understood that both the foregoing general description and the following detailed description are exemplary and explanatory only and are not restrictive of the invention, as claimed. It may be noted that, as used in the specification and the appended claims, the singular forms “a”, “an” and “the” include plural referents unless the context clearly dictates otherwise. Thus, for example, reference to “a material” may include mixtures of materials, reference to “a compound” may include multiple compounds, and the like. References cited herein are hereby incorporated by reference in their entirety, except to the extent that they conflict with teachings explicitly set forth in this specification.

In this specification and in the claims which follow, reference will be made to a number of terms which shall be defined to have the following meanings:

“Optional” or “optionally” means that the subsequently described circumstance may or may not occur, so that the description includes instances where the circumstance occurs and instances where it does not. For example, if a device optionally contains a feature for a barrier film, this means that the barrier film feature may or may not be present, and, thus, the description includes both structures wherein a device possesses the barrier film feature and structures wherein the barrier film feature is not present.

Various interconnect schemes exist to connect multiple solar cells into a panel. Nanosolar has developed a back-contact solar cell that allows for a more effective interconnect of cells into strings, wherein multiple strings form one panel.

This embodiment of the present invention sets forth a method of laminating two layers of metal (or one metal and one metalized polymer/plastic/or polyimide) together, while insulating them from each other, using a material such as but not limited to a thermoplastic as the bonding agent and an energy source as the catalyst. Some embodiments may use layer(s) that only coated or treated with a thermoplastic. One or both foil layers may be so treated. This step may be useful in forming the back-contact solar cell. In one embodiment, the method involves laminating two layers of metal together, while insulating them from each other without the use of chemical adhesives. By way of nonlimiting example, the bonding agent is a thermoplastic, and the bonding method is by way of burst lamination, which may use an energy source selected from one or more of the following: radiant heating, invective heating, inductive heating, flash heating, flame heating, energy from combustion, a stream of burning vapor or gas, and/or IR heating. Flame laminating may be used to join dissimilar sheets of material when one is a thermoplastic. Heating may optionally be of both metal layers, only the top metal layer, and/or only the bottom metal layer. A continuous fusing process to bond film and/or metal to another layer by passing materials over a gas flame. The resulting bond exhibits strength and durability. Multiple flame lamination lines may be used to laminate as many as three substrates up to 2 meters wide or wider.

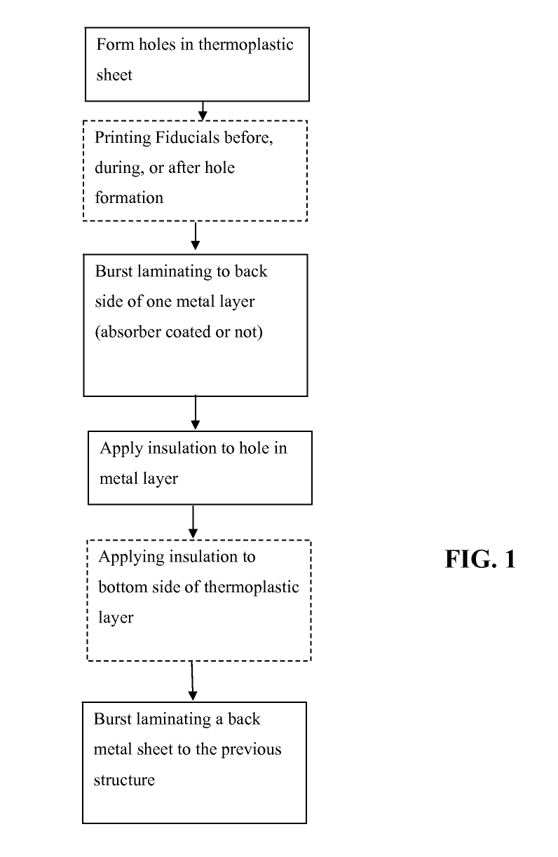

By way of nonlimiting example and referring to FIG. 1, laminating of two metal sheets using a thermoplastic as the insulator/bonding agent may comprise of:

1. Punching holes in a thermoplastic sheet at a pre-selected pitch that matches the pitch of the metal sheet. In one embodiment, the holes in the thermoplastic sheet are larger than the corresponding holes in the metal foil coated with the thin film absorber. Optionally, in other embodiments, the holes in the foil are larger than the holes in the thermoplastic sheet.

2. Optionally, printing fiducials at the same time for reference throughout the process.

3. Burst laminating the thermoplastic sheet to the back side of the CIGS (or other absorber or thin-film absorber) coated metal foil or substrate, aligning the holes in the thermoplastic around the holes in the metal foil. The larger holes in the thermoplastic allows for more process variation in the alignment.

4. Applying a insulation from the top side (active side) to insulate the hole in the metal. The insulation may be liquid insulation. Clear the hole by air, suction, laser, or other via clearing method.

5. Optionally, applying a second application of insulation to the bottom side, entirely filling the hole punched in the thermoplastic. The insulation may be liquid insulation. Clear the hole with air, suction, laser, or other via clearing method. .

6. Burst laminating the back metal sheet onto the previous structure.

Of course, it should be understood that the process may be varied by applying the thermoplastic material firs to the back metal sheet and then attaching that layer to the layer with the metal layer with the absorber coating.

### Innovation(s)

In one embodiment, the present invention comprises of laminating two metal foil sheets together without the use of common liquid adhesives, while creating an electrical insulation between the two layers.

### Elements of this Embodiment of the Invention

Pre punch the holes in the plastic bigger than is necessary

Burst laminate the thermoplastic to the top metal foil.

Burst laminate the thermoplastic and top foil to the bottom foil.

The burst may provide rapid heating sufficient to cause lamination of the thermoplastic to the foil without damaging the thin film absorber and without using adhesives. Some embodiments may cool one side of the foil with the absorber while the other side is heated for burst lamination. The burst laminate process can be used to heat activate hot melt films. The thickness of the thermoplastic layer may be thicker initially to compensate for material loss or shrinkage due to burst or heat lamination. The actual temperature of the flame depends on the gas used, but is selected so as not to damage the thin-film absorber on the metal foil.

### Advantages

Line speeds are much greater than other forms of adhesive

It offers excellent bond line control, (thickness of insulator)

Low to no Voc emitted.

Excellent bond strength

No curing time

Low cost adhesive/insulator

Extremely durable

In one preferred embodiment, the thin film solar panels uses solar cells with two layers of metal as the primary conductors.

### Alternative Embodiments

1. Apply strips of thermoplastic by way of burst lamination, leaving strips of the metal foil uncovered. The uncovered strips would then be filled with adhesive/insulator.

2. Apply full sheets of thermoplastic by way of burst laminating and drill the holes in the insulator with laser.

While the invention has been described and illustrated with reference to certain particular embodiments thereof, those skilled in the art will appreciate that various adaptations, changes, modifications, substitutions, deletions, or additions of procedures and protocols may be made without departing from the spirit and scope of the invention. For example, with any of the above embodiments, it should be understood that they are not limited to any one type of thin-film absorber material. They may be formed in roll to roll or in batch configuration. By way of nonlimiting example, the attachment of two metal layers is of use in embodiments such as those found in U.S. patent application Ser. No. ______ (Attorney Docket NSL-043) and fully incorporated herein by reference. Fusing equipment may be found with reference to DELA Incorporated 175 Ward Hill Avenue Ward Hill, Mass.

Furthermore, those of skill in the art will recognize that any of the embodiments of the present invention can be applied to almost any type of solar cell material and/or architecture. For example, the absorber layer in solar cell 10 may be an absorber layer comprised of silicon, amorphous silicon, copper-indium-gallium-selenium (for CIGS solar cells), CdSe, CdTe, Cu(In,Ga)(S,Se)₂, Cu(In,Ga,Al)(S,Se,Te)₂, other absorber materials, IB-IIB-IVA-VIA absorbers, or other alloys and/or combinations of the above, where the active materials are present in any of several forms including but not limited to bulk materials, micro-particles, nano-particles, or quantum dots. The CIGS cells may be formed by vacuum or non-vacuum processes. The processes may be one stage, two stage, or multi-stage CIGS processing techniques. Additionally, other possible absorber layers may be based on amorphous silicon (doped or undoped), a nanostructured layer having an inorganic porous semiconductor template with pores filled by an organic semiconductor material (see e.g., US Patent Application Publication US 2005-0121068 A1, which is incorporated herein by reference), a polymer/blend cell architecture, organic dyes, and/or C₆₀ molecules, and/or other small molecules, micro-crystalline silicon cell architecture, randomly placed nanorods and/or tetrapods of inorganic materials dispersed in an organic matrix, quantum dot-based cells, or combinations of the above. Many of these types of cells can be fabricated on flexible substrates.

Additionally, concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a size range of about 1 nm to about 200 nm should be interpreted to include not only the explicitly recited limits of about 1 nm and about 200 nm, but also to include individual sizes such as 2 nm, 3 nm, 4 nm, and sub-ranges such as 10 nm to 50 nm, 20 nm to 100 nm, etc. . . .

The publications discussed or cited herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed. All publications mentioned herein are incorporated herein by reference to disclose and describe the structures and/or methods in connection with which the publications are cited.

While the above is a complete description of the preferred embodiment of the present invention, it is possible to use various alternatives, modifications and equivalents. Therefore, the scope of the present invention should be determined not with reference to the above description but should, instead, be determined with reference to the appended claims, along with their full scope of equivalents. Any feature, whether preferred or not, may be combined with any other feature, whether preferred or not. In the claims that follow, the indefinite article “A”, or “An” refers to a quantity of one or more of the item following the article, except where expressly stated otherwise. The appended claims are not to be interpreted as including means-plus-function limitations, unless such a limitation is explicitly recited in a given claim using the phrase “means for.”

What is claimed is:

1. A method of solar cell manufacturing comprising:
using an energy increase as a catalyst to laminate a first metal layer to a second metal layer with an electrically insulating layer therebetween without damaging an absorber layer formed on the first metal layer.
